(19) United States
(12) Patent Application Publication
(10) Pub. No.: US 2017/0090446 A1
(43) Pub. Date: Mar. 30, 2017

(54) WEARABLE TASTE GENERATION DEVICE

(71) Applicant: INTERNATIONAL BUSINESS MACHINES CORPORATION, ARMONK, NY (US)

(72) Inventors: YUK L. CHAN, ROCHESTER, NY (US); MICHAEL D. ESSENMACHER, DANBURY, CT (US); DAVID B. LECTION, RALEIGH, NC (US); ERIC L. MASSELLE, RALEIGH, NC (US)

(21) Appl. No.: 14/868,630

(22) Filed: Sep. 29, 2015

(51) Int. Cl. G05B 19/042; G05B 19/048

(52) U.S. Cl. CPC G05B 19/042; A23L 1/22; G05B 19/048; A23V 2002/00; G05B 2219/1103

(57) ABSTRACT

Embodiments include wearable taste generation devices, methods and computer program products for operating the same. Aspects include receiving information regarding an ingestible item, the information includes one or more characteristics of the ingestible item and comparing the one or more characteristics to a user profile. Aspects also include identifying one or more flavorants based on the comparison and dispensing the one or more flavorants when the ingestible item is being ingested by a user.

### BACKGROUND

The present disclosure relates to wearable devices and more specifically, to wearable taste generation devices and methods for operating the same.

The availability and adoption of wearable devices, including smart glasses, watches and fitness tracers, has dramatically increased in recent years. These wearable devices provide individual customizations which have enabled them to become integral to their user's daily life. Several different applications have been developed for these devices, from improving shopping convenience to monitoring medical conditions. Additionally, as more wearable devices and applications become available, more useful and appealing uses will emerge, and the market size will increase as well.

While several wearable devices are currently used to track exercise to promote a healthy lifestyle and to promote weight loss, many health issues that an individual experiences are related, directly or indirectly, to the food intake of the individual. Accordingly, a wearable device that is configured to manipulate the taste of food for an individual could be used to assist individuals in maintaining a healthy diet, for health reasons or for personal preference.

### SUMMARY

In accordance with an embodiment, a method of operating a wearable taste generation device is provided. The method includes receiving, by a processor, information regarding an ingestible item, the information including one or more characteristics of the ingestible item, and comparing the one or more characteristics to a user profile. The method also includes identifying one or more flavorants based on the comparison and dispensing the one or more flavorants when the ingestible item is being ingested by a user.

In accordance with another embodiment, a wearable taste generation device has a processor in communication with a memory. The processor is configured to receive information regarding an ingestible item, the information including one or more characteristics of the ingestible item, and to compare the one or more characteristics to a user profile. The processor is also configured to identify one or more flavorants based on the comparison and to dispense the one or more flavorants when the ingestible item is being ingested by a user.

In accordance with a further embodiment, a computer program product for operating a wearable taste generation device includes a non-transitory storage medium readable by a processing circuit and storing instructions for execution by the processing circuit for performing a method. The method includes receiving information regarding an ingestible item, the information including one or more characteristics of the ingestible item, and comparing the one or more characteristics to a user profile. The method also includes identifying one or more flavorants based on the comparison and dispensing the one or more flavorants when the ingestible item is being ingested by a user.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a block diagram illustrating a wearable taste generation device in accordance with an exemplary embodiment;

FIG. 2 is a block diagram illustrating another wearable taste generation device in accordance with an exemplary embodiment;

FIG. 3 is a flow diagram of a method for operating a wearable taste generation device in accordance with an exemplary embodiment; and

FIG. 4 is a flow diagram of another method for operating a wearable taste generation device in accordance with an exemplary embodiment.

### DETAILED DESCRIPTION

In accordance with exemplary embodiments of the disclosure, methods, systems and computer program products for wearable taste generation are provided. In exemplary embodiments, a taste modification/generation device is a wearable device designed to be worn inside of the mouth. The wearable taste generation device can be configured to alter the messages the taste receptors and tissues in the mouth send to the brain regarding the flavor and other sensory information associated with food, drink, or other ingestible substances put into the mouth by chemically blocking or physically covering them. In exemplary embodiments, the wearable taste generation device can be configured to alter the overall taste experience for an extended period of time, for example, across an entire day, or for several days, weeks, months, etc. As a result, the wearable taste generation device would allow the user to make a decision to stop eating and drinking unhealthy things just once and enjoy the benefits of that one decision for days, weeks, or months. Once the wearable taste generation device is in place and the sense of taste is altered, the user may learn new behaviors on how to eat, what to eat, and why to eat, without having to rely solely on willpower to make healthy eating choices.

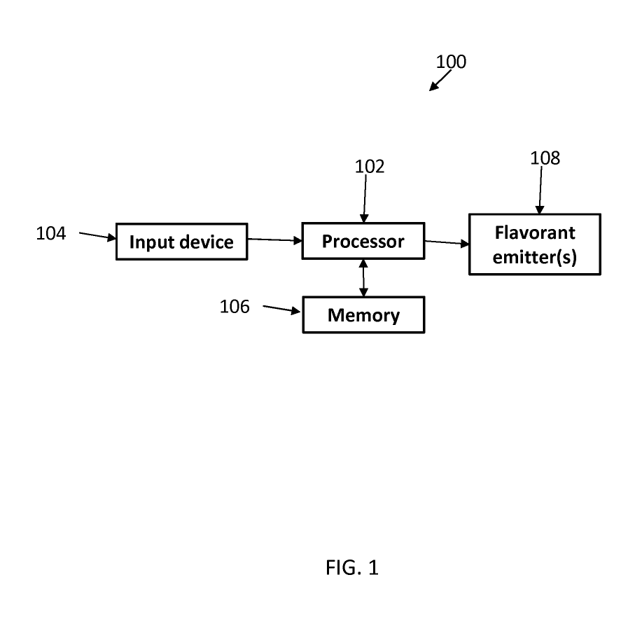

Referring to FIG. 1, there is shown a block diagram of an embodiment of a wearable taste generation device 100. As illustrated, the wearable taste generation device 100 includes a processor 102 that is configured to receive an input signal from one or more input devices 104 and to be communicatively coupled to a memory 106. The processor 102 is configured to compare the input signals from the input device 104 to a user profile stored in the memory 106 and to responsively provide commands to the flavorant emitter 108.

In exemplary embodiments, the input device 104 may include one or more sensors disposed inside of a user's mouth that are configured to monitor one or more characteristics of an ingestible item consumed by the user. The sensors may include various know types of sensors that are capable of being deployed inside of the user's mouth. For example, the input device 104 may include electrical and/or optical sensors that can be configured to measure a salinity level inside the mouth, a pH inside the mouth, and conductivity inside the mouth, which may serve as indicators of the characteristics of items ingested by the user. In exemplary embodiments, the flavorant emitter 108 may include multiple flavorant emitters that are configured to emit different flavorants onto different parts of a user's tongue. For example, a sweet flavorant, such as sugar, can be targeted at the front of the tongue, which is the most sensitive to sweet taste. Other flavorants can include garlic, chocolate, MSG, and the like.

In exemplary embodiments, the flavorant emitter 108 includes a compartment of flavorant, a secretion head, and an electronic circuit that selects and secretes a specific flavorant. In one embodiment, the wearable taste generation device 100 includes multiple flavorant containers located in different locations on a dental structure. Each container could contain one or more flavorants, and positioned near the most sensitive area of the tongue or other taste sensing area of the mouth (i.e., a sweetener could be positioned in the front, where the front of the tongue is most sensitive to sweet taste). In one embodiment, the flavorant can be delivered from a cartridge, which can be refilled/replaced as needed. The flavorant could be any of the highly concentrated chemicals used typically in food processing today. As technology become more sophisticated, the cartridge and flavorant will become smaller and more cartridges can be added.

In exemplary embodiments, the processor 102 is a hardware device for executing hardware instructions or software, particularly that stored in a non-transitory computer-readable memory (e.g., memory 106). Processor 102 can be any custom made or commercially available processor, a central processing unit (CPU), a plurality of CPUs, a semiconductor based microprocessor (in the form of a microchip or chip set), a macroprocessor, or generally any device for executing instructions. Processor 102 can include a memory cache, which may include, but is not limited to, an instruction cache to speed up executable instruction fetch, a data cache to speed up data fetch and store, and a translation lookaside buffer (TLB) used to speed up virtual-to-physical address translation for both executable instructions and data.

In exemplary embodiments, the memory 106 can include random access memory (RAM) and read only memory (ROM). The RAM can be any one or combination of volatile memory elements (e.g., DRAM, SRAM, SDRAM, etc.). ROM 108 can include any one or more nonvolatile memory elements (e.g., erasable programmable read only memory (EPROM), flash memory, electronically erasable programmable read only memory (EEPROM), programmable read only memory (PROM), tape, compact disc read only memory (CD-ROM), disk, cartridge, cassette or the like, etc.). Moreover, memory 106 may incorporate electronic, magnetic, optical, and/or other types of non-transitory computer-readable storage media.

The instructions in memory 106 may include one or more separate programs, each of which comprises an ordered listing of computer-executable instructions for implementing logical functions. In one example, the instructions in memory 106 may include a suitable operating system that is configured to control the execution of other computer programs and provides scheduling, input-output control, file and data management, memory management, and communication control and related services.

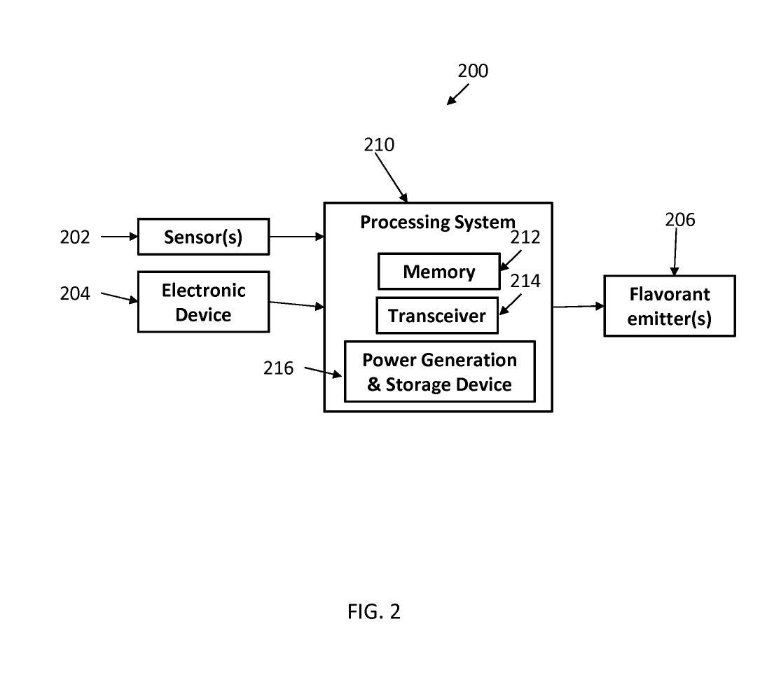

Referring now to FIG. 2, a wearable taste generation device 200 in accordance with another embodiment is illustrated. As illustrated, the wearable taste generation device 200 includes a processing system 210, one or more sensors 202, an electronic device 204, and one or more flavorant emitters 206. In exemplary embodiments, the processing system 210 is communicatively coupled, for example by the transceiver 214, to the one or more sensors 202, the electronic device 204, and the one or more flavorant emitters 206. The processing system 210 includes a memory 212, one or more transceivers 214 and a power generation and storage device 216.

In exemplary embodiments, the one or more sensors 202 are disposed inside of a user's mouth and are configured to monitor one or more characteristics of an ingestible item consumed by the user. The one or more sensors 202 may be configured to determine a taste level, also referred to as a characteristic, of the ingested item (which could be in liquid, gas or solid form). The taste level could be determined using any available mechanism. In one example, one sensor can monitor the pH inside the mouth, which can be used as an indicator for acidity level of the food.

In exemplary embodiments, the electronic device 204 may be a smartphone or other electronic device and is configured to receive an input of a description of a food that the user is about to consume via a user interface. In exemplary embodiments, the electronic device 204 may include a variety of external devices, including a camera, smartphone, optical head mounted display (OHMD) device that can indicate the food about to be ingested. In one example, a restaurant may provide a customized QR tag, or RFID tag, for each dish it cooked, and attach the QR or RFID tag to the plate. The electronic device 204 can be used to retrieve the characteristics associated with the dish by reading the QR/RFID tags.

In one embodiment, the power generation and storage device 216 includes a generator that is configured to create an electric charge by the mouth motion. In another embodiment, the power generation and storage device 216 includes a wireless electric power receiver configured to receive power from another portable device. The power generation and storage device 216 also includes a battery configured to store energy that is used to power one or more of the processor, processing system, sensors and flavorant emitter.

The processing system 210 is configured to receive signals from one or more sensors 202 and/or the electronic device 204 and to retrieve data from a user profile stored in the memory 212. The processing system 210 determines one or more of a type of flavorant to be dispensed, an amount of flavorant to be dispensed and a location to dispense the flavorant at and responsively provides appropriate commands to the flavorant emitters 206. In exemplary embodiments, the user profile is configured to store the user's preference on the taste of the food that they consume. In one embodiment, the user preference could be done through manual configuration, via a user interface of the electronic device, where user will indicate the suitable sugar, salt content based on preference or health goal, or training, where user will indicate “satisfaction” level for the current food being ingested. The taste preference may be configured for specific type or category of food. For example, the user may prefer their desert very sweet, but prefers to go light on salt for meat.

The processing system 210 is used to determine the amount of flavorant to be secreted by the flavorant emitter 206. The processing system 210 uses the user profile to determine the desired taste level, and compares it with the taste level based on the sensors and/or user input. In one embodiment, the difference is the initial amount of flavorant to secrete. It is possible that the flavorant quantity required to create the same desired human response is different from the “difference” calculated above. The relationship between the flavorant and differences could be learned through additional training and store in the user profile. In exemplary embodiments, the processing system 210 can control where in the mouth the flavorant secretion occurs to target specific areas of the tongue. This would create an effect where a lesser amount of salt or sugar could create the same effect as the full amount of flavorant all over the mouth.

In exemplary embodiments, the wearable taste generation device can be configured to take the form of a dental crown, dental bridge, braces, a dental retainer or any other form secured on the dental structure. In one embodiment, the wearable taste generation device is configured to attach to the teeth such that it will cover a portion of the roof of the mouth. In another embodiment, the wearable taste generation device is configured to attach to the teeth such that it will reside along or in the lower arch of the mouth, adjacent to or beneath the tongue. In exemplary embodiments, the wearable taste generation device may be configured as a single device or it may include multiple devices that are in communication with one another.

In exemplary embodiments, part or the entire wearable taste generation device may be permanently attached within the oral cavity, or, in some embodiments, part or all of the wearable taste generation device may be removable or replaceable by the user. Variations of a taste modification device may be coated, loaded, or designed in many different fashions to contain and release active ingredients such as gymnemic acid, which is a sweetness inhibitor, into the mouth in a sustained fashion.

In another embodiment, the taste modification device may be completely erodible, attaching to the tissue of the palate or other tissues such as the cheek or gums by way of a bio-adhesive material contained within or applied to one side of the device. Such an erodible device may be impregnated with active ingredients such as gymnemic acid that are released into the mouth in a sustained fashion as the taste modification device erodes away layer by layer.

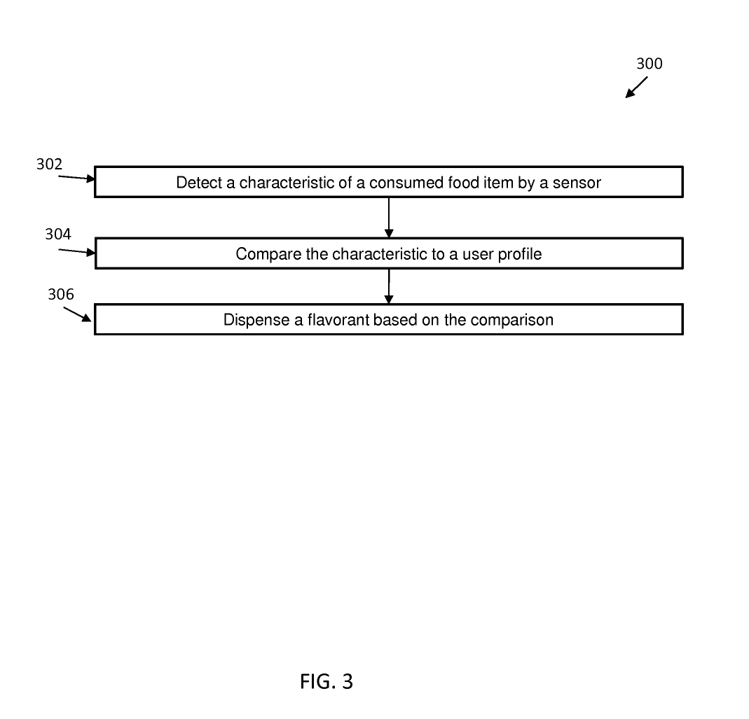

Referring now to FIG. 3, a flow diagram of a method 300 for operating a wearable taste generation device in accordance with an exemplary embodiment is shown. As shown at block 302, the method 300 includes detecting a characteristic of a consumed food item by a sensor. For example, the characteristic may include a pH level, a sugar level, salinity level or the like. Next, the method 300 includes comparing the characteristic to a user profile, as shown at block 304. In exemplary embodiments, the comparison may include the identification of one or more flavorants to be dispensed. In exemplary embodiments, the user profile may include multiple threshold values for desired user tastes and once a detected characteristic falls outside of an acceptable range, the method 300 includes dispensing a flavorant based on the comparison, as shown at block 306.

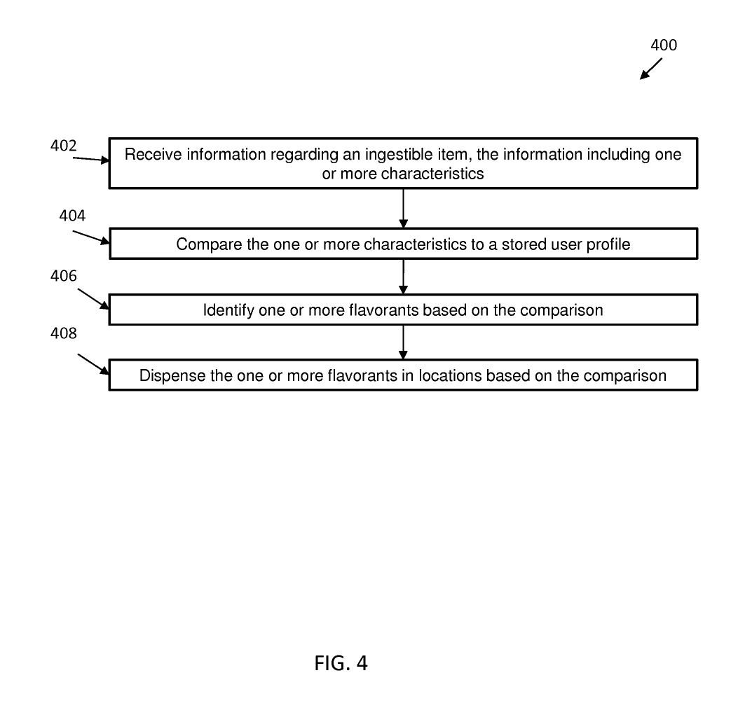

Referring now to FIG. 4, a flow diagram of another method 400 for operating a wearable taste generation device in accordance with an exemplary embodiment is shown. As shown at block 402, the method 400 includes receiving information regarding a food item that a user is consuming, the information include one or more characteristics. In exemplary embodiments, the information regarding the food item that the user is consuming may be received from one or more sensors inside the user's mouth or from an external electronic device, such as a smartphone or camera. Next, the method 400 includes comparing the one or more characteristics to a user profile, as shown at block 404. In exemplary embodiments, the user profile may include multiple threshold values for desired user tastes. Next, as shown at block 406, the method 400 includes identifying one or more flavorants based on the comparison. For example, if the pH level is determined to be below a desired level, the identified flavorant may be phosphoric acid. Next, as shown at block 408, the method 400 includes dispensing the one or more flavorants in locations determined based on the comparison. For example, if the flavorant to be dispensed is determined to be gymnemic acid, the location may be selected to be near the front of the tongue to maximize the effect of the gymnemic acid.

Methods described herein that modify taste perception as a means of controlling food intake and weight loss is referred to as taste modification therapy. In one embodiment, taste modification therapy may begin by largely blocking a user's ability to taste food and gradually transitioning from the user experiencing almost no taste whatsoever to adding back in the ability to taste. In another embodiment, a user may only the ability to taste sweet blocked for a period of time, while other elements of taste remain unchanged. In a further embodiment, taste modification therapy can include blocking the ability to taste unhealthy sweetened or salty food, while enhancing the ability to enjoy healthy food through altering or enhancing interactions with and control of the taste bud receptor sites in the mouth. In exemplary embodiments, a variety of flavorants may be used for user desired flavor enhancement, in additional to taste therapy.

In exemplary embodiments, the user profile for achieving these taste modification therapies may be controlled by a user of by a clinician, such as a nutritionist or a doctor, which can create and modify the user profile of the wearable taste generation device. In exemplary embodiments, the wearable taste generation device may also be configured to keep a log of the food items eaten and the flavorants dispensed. This log can be accessed by the clinician to assess the effectiveness of the taste modification therapy and to make any desired adjustments to the user profile.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-7. (canceled)

8. A computer program product for operating a wearable taste generation device, the computer program product comprising:
a non-transitory storage medium readable by a processing circuit and storing instructions for execution by the processing circuit for performing a method comprising:
receiving, by a transceiver of the wearable taste generation device of a user, information regarding an ingestible item, the information including one or more characteristics of the ingestible item, wherein a first part of the information is received from an electronic device that is disposed outside of the mouth of the user and a second part of the information is received from one or more sensors disposed inside of the mouth of the user;
comparing the one or more characteristics to a user profile, wherein the user profile is received from the electronic device and stored in a memory disposed in the wearable taste generation device;
identifying one or more flavorants based on the comparison; and
dispensing the one or more flavorants identified when the ingestible item is being ingested by the user, wherein the dispensing is powered by a power generation and storage device that is configured to create an electric charge by a motion of the mouth
wherein the one or more flavorants are dispensed in a location inside the mouth of a user that is determined based on a type of the one or flavorants that are identified.

9. (canceled)

10. (canceled)

11. The computer program product of claim 8, wherein the electronic device includes an RFID tag associated with the ingestible item.

12. The computer program product of claim 8, wherein the one or more characteristics include one or more of a salinity level, a pH level and a sugar level.

13. (canceled)

14. The computer program product of claim 8, wherein the type of the flavorants is determined based on the comparison of the one or more characteristics to the user profile.

15. A wearable taste generation device comprising:
a processor in communication with a memory, the processor configured to:
receive information regarding an ingestible item, the information including one or more characteristics of the ingestible item, wherein a first part of the information is received by a transceiver in communication with the processor from an electronic device that is disposed outside of the mouth of a user and a second part of the information is received from one or more sensors disposed inside of the mouth of the user;
compare the one or more characteristics to a user profile, wherein the user profile is received from the electronic device and stored in the memory disposed in the wearable taste generation device;
identify one or more flavorants based on the comparison; and
instruct an emitter to dispense the one or more flavorants when the ingestible item is being ingested by the user, wherein the dispensing is powered by a power generation and storage device that is configured to create an electric charge by a motion of the mouth,
wherein the one or more flavorants are dispensed in a location inside the mouth of a user that is determined based on a type of the one or flavorants that are identified.

16. (canceled)

17. (canceled)

18. The wearable taste generation device of claim 15, wherein the electronic device includes an RFID tag associated with the ingestible item.

19. (canceled)

20. The wearable taste generation device of claim 19, wherein the type of the flavorants is determined based on the comparison of the one or more characteristics to the user profile.
